(19) United States
(12) Patent Application Publication
(10) Pub. No.: US 2021/0039739 A1
(43) Pub. Date: Feb. 11, 2021

(54) Cross Axis Helical gear set based Steering System for Reverse Trikes

(71) Applicant: Ravi Shankar GAUTAM, Gaya (IN)

(72) Inventor: Ravi Shankar GAUTAM, Gaya (IN)

(21) Appl. No.: 16/976,085

(22) PCT Filed: Feb. 28, 2019
(86) PCT No.: PCT/IN2019/050169

§ 371 Date: Aug. 27, 2020

(30) Foreign Application Priority Data
Feb. 28, 2018 (IN) 201821007634

(51) Int. Cl. B62K 5/08; B62K 5/05; B62K 21/02; B62K 21/12; B62K 21/06

(52) U.S. Cl. CPC B62K 5/08; B62K 5/05; F16H 1/225; B62K 21/12; B62K 21/06; B62K 21/02

(57) ABSTRACT

This non-tilting steering system for reverse trikes uses three cross axis helical gear set. Steerer rod at the center, and steerer rod controlling the wheels are connected to cross axis helical gear set. Central gear set as well as gear set on the wheel consist of one vertical helical gear meshingly engaged, on its front and rear side, with two transversely oriented horizontal helical gears. Steerer rod at the center upon rotation via handle rotates coaxial worm gear which in turn rotates pinion helical gears engaged with it. Pinion helical gears at the center then rotates transverse helical gears of the gear set of the steering system at each of the wheels via a transmission shaft which in turn rotates the vertical helical gears attached to steerer rods of the wheels, thus rotating the wheels. This steering system can also be used in a four wheeler.

### FIELD OF INVENTION

Non-tilting steering system for reverse trike.

### BACKGROUND OF INVENTION

It is obvious that reverse trikes are more safe and stable than bikes and conventional trikes. Reverse trikes have many mechanical advantages over conventional trikes which include stability, traction in uphills and steerability. But providing an efficient steering mechanism for reverse trikes is a challenge. In recent past many models of reverse trikes have come up in the public domain offering tilting steering system. Tilting steering system has many issues which includes traction as well as ground clearance while cornering around a turn. Non-tilting steering system for reverse trikes have drawn little attention as it is understood by majority of folks that rack and pinion steering mechanism used in cars is sufficient for the purpose. But it has its own issues which includes big reduction ratio and too complex mechanism to handle on a trike. Non-tilting steering system is provided in Newton reverse trike. It employs pitman arm to swing the kingpin attached to spindle mounted on each of the two front steer wheels.

### TECHNICAL PROBLEM

Steering mechanism of reverse trike or four wheelers have externally moving parts in the form of steer transmission rods. It may be huge disadvantage in case of uneven land mass caused during snow fall.

Rotation motion is converted into translational motion which is then converted back to rotation motion

Non-tilting steering mechanism in Newton reverse trike applies the steering torque on the two wheels either from the front side of the head tube or rear side of the head tube due to which force gets exerted on the head tube rearward or forward direction respectively, thus making it difficult to operate as compared to steering system for a bicycle. In bicycles steering torque applied on the wheel is symmetric along the head tube.

### SUMMARY OF INVENTION

One of our objective is to provide steering system for reverse trike which is as ergonomic to operate as that of a bicycle.

To achieve this objective steering system for reverse trike is designed such that two front wheels can be transversely rotated using coupled torque. Steering torque is applied on each of the front wheels symmetrically on both ends of the axle and symmetrically on front and rear side of the steerer rods, thereby providing easy and stable maneuverability to the steering system. Head tube is proportional to the length of steerer rod to provide sturdiness to steerer rod.

Wheels can be turned by 360 degree.

Rotation steering action at the handle is transmitted as steering action on the wheel through rotation motion and is not converted into translational motion as intermediate phase.

It has no externally moving parts.

### BRIEF DESCRIPTION OF DRAWINGS

FIG. 1 and FIG. 2 Side and Top view respectively of reverse trike with cross-axis helical gear set based coupled torque steering system according to this invention.

FIG. 3 and FIG. 4 Rear and front view respectively of cross-axis helical gear set based coupled torque steering system according to this invention.

FIG. 5 Cross-axis helical gear set based steering system according to this invention without head tubes.

FIG. 6 Central, left and right cross-axis helical gear set used in steering mechanism according to this invention.

FIG. 7 Central, left and right cross-axis helical gear set used in steering mechanism without head tube arms according to this invention.

FIG. 8 Reverse trike with rotated front wheels due to steering action by steering system according to this invention.

### DESCRIPTION OF EMBODIMENTS

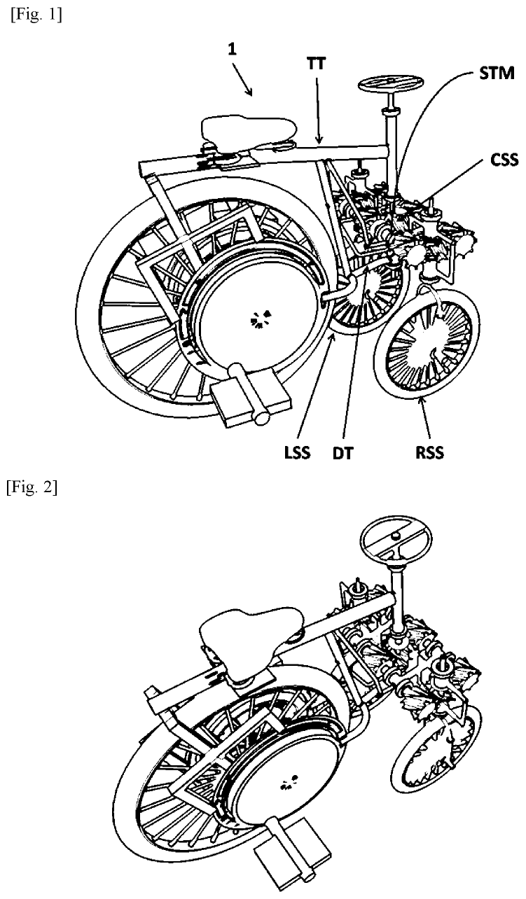

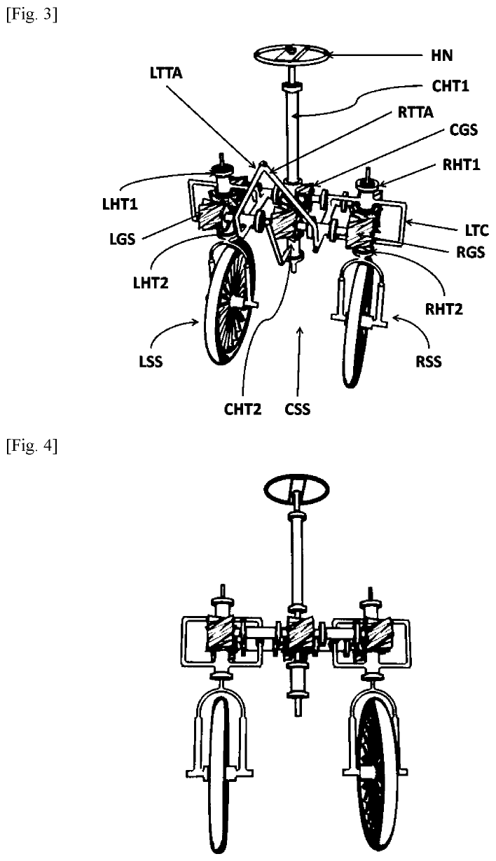

As shown in [FIG. 1] and [FIG. 3], cross axis helical gear set based coupled torque steering system for reverse trike (1) with top tube (TT) and down tube (DT), according to this invention comprises central steering system (CSS), left wheel steering system (LSS), right wheel steering system (RSS), steer transmission mechanism (STM), steering support mechanism (SSM).

### Central Steering System

As shown in [FIG. 1] and [FIG. 3], central steering system consists of central steering shaft (CST), central head tube (CHT), central gear set (CGS).

As shown in [FIG. 1] and [FIG. 3], central steering shaft (CST) is a straight shaft, connected to a handle at its top, located on the center of the front part of reverse trike.

As shown in [FIG. 1] and [FIG. 3] central head tube (CHT) is a set of two sections of vertical tubes, upper section (CHT1) and lower section (CHT2) separated by distance equal to the height of central gear set with each section coaxially holding the central steering shaft using ball bearings and upper section on its rear attached to top tube (TT) and lower section attached on its rear side to down tube (DT).

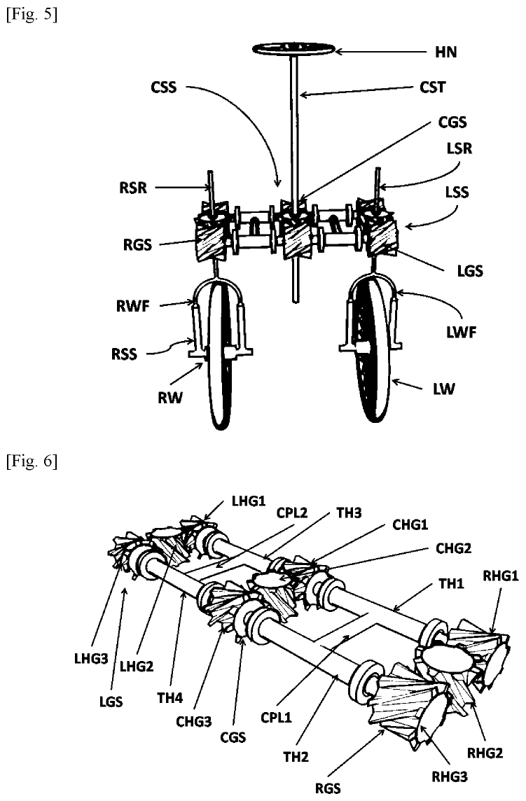

As shown in [FIG. 3], [FIG. 5] and [FIG. 6] central gear set (CGS) consists of one vertical helical gear (CHG2) meshingly engaged, on its front and rear side, with a pair of transversely oriented horizontal helical gears (CHG1) and (CHG3). Helical gear (CHG2) is coaxially fixedly mounted on the central steerer rod. Central pinion helical gears (CHG1) and (CHG3) are held in place by steer transmission mechanism (STM).

### Left Wheel Steering System

As shown in [FIG. 1] and [FIG. 3], left wheel steering system consists of a wheel (LW), left steering fork (LSF), left head tube (LHT), left gear set (LGS) and left tubular cage (LTC).

As shown in [FIG. 1] and [FIG. 3], left wheel steering fork (LSF) is a rigid/suspension fork with steerer rod (LSR) with fork blades at their ends holding the wheel (LW) at the ends of its axle. Left head tube (LHT) is a set of two sections of vertical tubes, upper section (LHT1) and lower section (LHT2) separated by distance equal to the height of left wheel gear set (LGS) with each section coaxially holding the central steering shaft using ball bearings.

As shown in [FIG. 3], [FIG. 5] and [FIG. 6], left gear set (LGS) consists of one vertically oriented helical gear (LHG2) coaxially fixedly mounted on the steerer rod of the left wheel (LSR) and is meshingly engaged on its front and rear side, with a pair of transversely oriented horizontal helical gear (LHG1) and (LHG3).

As shown in [FIG. 3], left wheel tubular cage (LTC) consists of two L-shaped rods and one C-shaped rod. One L-shaped rod is located on upper right side of left wheel steerer rod (LSR) and connects upper section left head tube (LHT1) to coupling rod (CPL1) of steer transmission mechanism (STM). One L-shaped rod is located on lower right side of left wheel steerer rod (LSR) and connects lower section left head tube (LHT2) to coupling rod (CPL1) of steer transmission mechanism (STM). C-shaped rod is located on right side of right wheel steerer rod (RSR) connects upper section of right head tube (RHT1) to lower section of right head tube (RHT2).

As shown in [FIG. 3], [FIG. 5] and [FIG. 6] left wheel worm gears (LHG1) and (LHG3) are held in place by steer transmission mechanism (STM).

### Right Wheel Steering System

As shown in [FIG. 1] and [FIG. 3], right wheel steering system consists of a wheel (RW), right steering fork (RSF), right head tube (RHT), right gear set (RGS) and right tubular cage (RTC). Right wheel steering fork (RSF) is a rigid/suspension fork with steerer rod (RSR) with fork blades at their ends holding the wheel (RW) at the ends of its axle. Right head tube (RHT) is a set of two sections of vertical tubes, upper section (RHT1) and lower section (RHT2) separated by distance equal to the height of central gear set with each section coaxially holding the central steering shaft using ball bearings.

As shown in [FIG. 3], [FIG. 5] and [FIG. 6], right gear set (RGS) consists of one vertically oriented helical gear (RHG2) coaxially fixedly mounted on the steerer rod of the right wheel (RSR) and is meshingly engaged on its front and rear side, with a pair of transversely oriented horizontal helical gear (RHG1) and (RHG3).

As shown in [FIG. 3], right wheel tubular cage (LTC) consists of two L-shaped rods and one C-shaped rod. One L-shaped rod is located on upper left side of right wheel steerer rod (RSR) and connects upper section right head tube (RHT1) to coupling rod (CPL2) of steer transmission mechanism (STM). One L-shaped rod is located on lower left side of right wheel steerer rod (LSR) and connects lower section right head tube (RHT2) to coupling rod (CPL2) of steer transmission mechanism (STM). C-shaped rod is located on right side of right wheel steerer rod (RSR) connects upper section of right head tube (RHT1) to lower section of right head tube (RHT2).

As shown in [FIG. 3], [FIG. 5] and [FIG. 6], right wheel helical gears (RHG1) and (RHG3) are held in place by steer transmission mechanism (STM).

### Steer Transmission Mechanism

As shown in [FIG. 3], [FIG. 5] and [FIG. 6], central steering system is coupled with left wheel steering system and right wheel steering system via steer transmission mechanism (STM). Steer transmission mechanism (STM) consists of four transverse straight shafts, one transverse shaft (TS1) on right front side coaxially connecting central pinion spur gear (CHG1) to right wheel front worm gear (RWG1), one transverse shaft (TS2) on right rear side coaxially connecting central pinion spur gear (CHG3) to right wheel front worm gear (RHG3), one transverse shaft (TS3) on left front side coaxially connecting central pinion spur gear (CHG1) to left wheel front worm gear (LHG1), one transverse shaft (TS4) on left rear side coaxially connecting central pinion helical gear (CHG3) to right wheel rear pinion helical gear (LHG3)

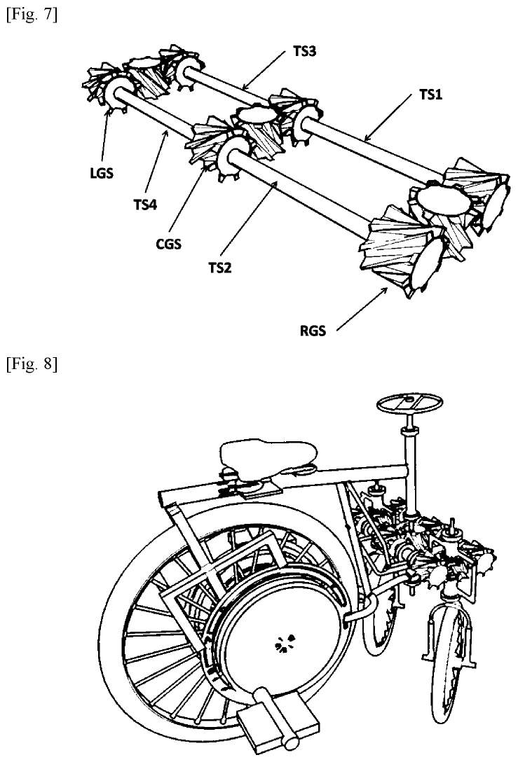

As shown in [FIG. 6] and [FIG. 7], transverse shaft (TS1), (TS2), (TS3) and (TS4) are coaxially encased in straight tubes, right front head tube arm (TH1) right rear head tube arm (TH2), left front head tube arm (TH3) and left rear head tube arm (TH4) respectively, via ball bearings.

As shown in [FIG. 3] and [FIG. 6], head tube arms on the right side (TH1) and (TH2) are connected by a tube (CPL1) and head tube arms on the left side (TH3) and (TH4) are connected by a tube (CPL2).

As shown in [FIG. 3], head tube arms on the left side and right side are connected at their rear side to top tube via rods left top tube arm (LTTA) and right top tube arm (RTTA) respectively.

### Steer Operation

On rotation in clockwise direction, handle causes vertical helical gear (CHG2) to rotate clockwise direction which in turn causes transversely oriented gears (CHG1) and (CHG3) to rotate in opposite direction which in turn cause helical gears (LHG1) and (RHG1) to rotate clockwise direction and cause helical gears (LHG3) and (RHG3) to rotate anticlockwise direction respectively with respect to left steer transmission arm (TS1). Above mentioned rotation of helical gears (LHG1) and (LHG3) causes pinion helical gear (LHG2) to rotate in clockwise direction and rotation of helical gears (RHG1) and (RHG3) causes pinion spur gear (RHG2) to rotate in clockwise direction and thus steering the wheels in clockwise direction.

1. Coupled torque steering system comprising cross axis helical gear set based central steering system, left wheel steering system, right wheel steering system and steer transmission mechanism.

2. Right wheel steering system and left wheel steering system claimed in [claim 1] are located on the right and left side respectively on the front part of the reverse trike with each of them comprising a wheel, steering fork, head tube, tubular cage and cross axis helical gear set wherein
wheel is preferably of diameter less than the height of seat;
steering fork is a rigid/suspension fork with steerer rod connected at its crown and fork blades at their ends holding the wheel at the ends of its axle;
head tube consists of two vertical tubes, separated by distance of cross axis helical gear set, each coaxially encasing the steerer rod with the help of ball bearings;
cross axis helical gear set consists of two transversely oriented helical gear and a vertically oriented helical gear;
vertically oriented helical gear is coaxially fixedly mounted on the steerer rod the corresponding wheel;
transversely oriented helical gears are meshingly engaged with vertically oriented helical gear on its front and rear side;
each of transversely oriented helical gears are coaxially attached at their transversely inward end to transversely outward end of a steer transmission arm of steer transmission mechanism;
tubular cage for each wheel consists of one C-shaped rod and two L-shaped rods which directly or indirectly hold the pinion spur gear and worm gears in their designated places.

3. Central steering system claimed in [claim 1] located on centre of the front part of the reverse trike, comprises, central steering shaft, central head tube, central tubular cage and central cross axis helical gear set wherein
central steering shaft is a straight shaft with handle at its top;
central head tube consists of two vertical tubes as upper section and lower section separated by distance of central bevel-pinion gear set encasing the central steering shaft with the help of ball bearings with upper section connected at its rear side to the top tube of the reverse trike and lower section at its rear side is connected to the down tube of the reverse trike;
central worm gear set consists of a vertically oriented helical gear and two transversely oriented horizontal helical gears;
vertically oriented helical gear is coaxially fixedly mounted on the central steerer rod;
transversely oriented helical gears are meshingly engaged with vertically oriented helical gear on its front and rear side;
each of transversely oriented helical gears of central gear set are coaxially attached at each of their ends to transversely inward end of a steer transmission arm of steer transmission mechanism mentioned in [claim 1].

4. Tubular cage for the front wheels mentioned in [claim 2] are configured such that
C-shaped rod connects the lower and upper section of the head tube of the corresponding wheel at their transversely outward side;
both L-shaped rod for each wheel are located on transversely inward side of corresponding wheel;
one L-shaped rod on upper side of corresponding wheel gear set connects upper section of the head tube to the forward extending tube, connecting front and rear head tube arms, of the steer transmission mechanism mentioned in [claim 1];
one L-shaped rod on lower side connecting the lower section of the head tube to the forward extending tube, connecting front and rear head tube arms, of the steer transmission mechanism mentioned in [claim 1].

5. Central steering system is coupled with left wheel steering system and right wheel steering system via steer transmission mechanism mentioned in [claim 1].

6. Steer transmission mechanism mentioned in [claim 1] and [claim 6] consists of four steer transmission arms each of which is a transverse straight shaft, wherein
one transmission arm coaxially connects right side face of front side central pinion transversely oriented helical gear mentioned in [claim 3] to right wheel front worm gear mentioned in [claim 2];
one transmission arm coaxially connects right side face of rear side central pinion transversely oriented helical gear, mentioned in [claim 3], to right wheel rear pinion transversely oriented helical gear, mentioned in [claim 2];
one transmission arm coaxially connects left side face of front side central pinion transversely oriented helical gear to left wheel front pinion transversely oriented helical gear;
one transmission arm coaxially connects left side face of rear side central pinion transversely oriented helical gear to left wheel rear pinion transversely oriented helical gear;
each transmission arm is coaxially encased in head tube arm, which is straight tube, via ball bearings;
rear side head tube arm on the right side is connected to front side head tube arm on the right side via a forward extending tube;
rear side head tube arm on the left side is connected to front side head tube arm on the left side via a forward extending tube;
head tube arms on the left side and right side are connected at their rear side to top tube via appropriately bent rods.

7. Handle claimed in [claim 2] is preferably round handle with its center connected to the upper end of central steering shaft claimed in [claim 3], is located above the front end of the top tube of reverse trike at a height approximately equal to the height of seat.
